(19) United States
(12) Patent Application Publication
(10) Pub. No.: US 2019/0249920 A1
(43) Pub. Date: Aug. 15, 2019

(54) GRID VOLTAGE-OPERATED REFRIGERATING DEVICE

(71) Applicant: Eppendorf AG, Hamburg (DE)

(72) Inventors: Simon Clarke, Essex (GB); Gary Poole, Maldon (GB); George Mason, Maldon Essex (GB)

(73) Assignee: Eppendorf AG, Hamburg (DE)

(21) Appl. No.: 16/329,264

(22) PCT Filed: Aug. 9, 2017
(86) PCT No.: PCT/EP2017/070218

§ 371 Date: Feb. 28, 2019

(30) Foreign Application Priority Data
Aug. 30, 2016 (EP) 16186339.4

(51) Int. Cl. F25D 29/00; F25D 11/04; E05B 47/06

(52) U.S. Cl. CPC F25D 29/008; F25D 11/04; F25D 29/00; F25D 29/006; E05B 2047/0069; F25D 2400/36; F25D 2600/02; F25B 2500/27; E05B 47/0603

(57) ABSTRACT

The invention relates to a grid voltage-operated refrigerating device, in particular an ultra-low-temperature refrigerating device, comprising a refrigerator door (2) which has a closure lever (22) that is pivotally hinged between an open position and a locked position and comprising locking means (24) which are paired with the closure lever, have an electric motor-actuated and/or electromagnetically actuated locking element (26) and lock or release the pivoting of the closure lever depending on a code actuation that can be entered by an operator using a code input unit (20). The locking means and the code input unit are paired with an electronic control unit (14) and grid voltage-independent battery buffering means (13) such that in response to a grid voltage outage, the code actuation and a release for a specified minimum period of time are made possible without a grid voltage supply. Display means (18), which are paired with the control unit and which are provided on the refrigerator door in particular, are designed to allow the current internal refrigerator temperature of the refrigerating device to be displayed in the event of a grid voltage outage at least over the specified minimum period of time.

### BACKGROUND OF THE INVENTION

The present invention relates to a mains voltage-operated refrigerator device. A device of this kind is commonly known in particular in the field of ultra-low temperature refrigerator devices, namely refrigerator devices having cooling mode temperatures of <−50 ° C. of their interior intended for storing goods to be refrigerated, and is suitable for being secured against unintentional and/or unauthorized access to said interior.

Generic refrigerator devices of this kind are usually used to store biological samples or similar refrigerated goods which is often accompanied by the necessity of controlling access to refrigerated goods of this kind that often have to be stored for weeks or months at low target temperatures in order to prevent abuse for example. Another aspect of access control that is quite significant in practice resides in the problem that at the low cooling mode temperatures indicated, each opening causes icing effects, which, in turn, necessitate special measures to be taken in order to remove the ice or to still ensure low-temperature cooling.

For instance, US 2015/0013352 A1 discloses an ultra-low temperature refrigerator device which, generically, has a refrigerator door on which a locking lever hinged thereto to be pivotable between an open position and a locked position is provided.

In principle, it is also known for a locking lever of this kind to be provided with blocking means which, by means of an electromotively or electromagnetically actuated blocking bolt or a similar blocking element, for example, can prevent that the locking lever is pivoted and, thus, that the refrigerator door is opened. In this context, the option of releasing and blocking control of the blocking means by coding, such as by an RFID carrier that has to be brought into high-frequency detection range, additionally by means of a keyboard or other coding means, so that access can be secured in this way, frequently even in a noncontact manner and thus comfortable in terms of actuation, is considered known from the state of the art.

However, the electrical energy supply of the electronic and electromechanical components involved in these known devices will cause problems if an outage or a comparable malfunction affecting the continuous energy supply occurs. This is why it has to be ensured that potentially high-value refrigerated goods in the interior can be removed and, as appropriate, be transferred into a different refrigerator when such a malfunction occurs. It also has to be ensured that the refrigerator can still be opened in case of a mains voltage outage. The devices considered to be commonly known from the state of the art and provided with the code entry technology described above, for example, solve this problem by the blocking means being automatically unlocked in case of a mains voltage outage, thus allowing an operator to actuate an unblocked and thus unlocked locking lever to gain unhindered access to the refrigerator interior. For this purpose, electromagnetic actuators for driving a blocking bolt have fail-safe operating modes, namely normally monostable end positions, to which they automatically return when the current is turned off.

However, this approach means that the access protection against unauthorized opening as supposed to be provided by the code entry is weakened. For instance, the malfunction in the form of the mains voltage outage could be caused intentionally, with the intent to abuse, such as by pulling the plug in the case of refrigerator devices generically connected to common mains sockets. This will cause the blocking means to unlock the locking lever as described above under the assumption of the emergency mode without there being any additional security measures or measures checking for unauthorized access.

Moreover, in the described event of malfunction, the state of the art considered to be commonly known has the disadvantage that temperature indicators and other components which in particular indicate a cooling state of the refrigerated goods stored in the interior are inoperative and, in particular, thus cannot (or can no longer) inform operators of the nature of a current cooling state or of a current cooling mode temperature, for example, which in particular means that emergency measures for the refrigerated goods that need to be taken are rendered speculative and no longer offer any guarantee that critical cooling temperatures might not have been exceeded already.

### SUMMARY OF THE INVENTION

Therefore, the object of the present invention is to both improve a mains voltage-operated refrigerator device according to the preamble of the main claim in terms of its operating properties and access-protection properties in case of a mains voltage outage and, in the event of such an abnormal operating state, give operators the opportunity of assessing a state of refrigerated goods stored in the refrigerator so that suitable securing measures can be taken despite the mains voltage outage.

This object is attained by the mains voltage-operated refrigerating device having the features of the main claim; advantageous embodiments of the invention are described in the dependent claims. Additional protection within the scope of the invention is claimed for a preferred use of said mains voltage-operated refrigerator device in an ultra-low temperature cooling range, namely at a stationary cooling mode temperature of −50 ° C. of an interior of the refrigerator intended for storing goods to be refrigerated, wherein this temperature as the stationary operating temperature can also be lower and can preferably be −80 ° C. and below.

In an advantageous embodiment according to the invention, mains voltage-independent battery buffering means are assigned to the blocking means, the blocking means according to the invention comprising an electromotively or electromagnetically actuated blocking element, such as a blocking bolt. Said battery buffering means will interact with the code entry unit and with the electronic control unit in such a manner that in response to a mains voltage outage, code actuation and release of the locking lever for the refrigerator door by means of the blocking element are enabled for a predetermined minimum period after occurrence of the mains voltage outage. This period is advantageously set or configured in such a manner that it is at least 50 hours, preferably at least 72 hours, thus still allowing access to the refrigerated goods by unblocking in particular in consideration of weekends or similar periods without personnel present. Thereby, the present invention ensures that the code entry unit continues to operate in interaction with the blocking means during said minimum period; in other words, the locking lever can also only be released during said period by entering the correct code, i.e. by the intended proper code actuation. Thus, according to the invention, the securing function is maintained during this emergency mode, such that by contrast to the state of the art discussed above abuse and circumvention of the code security feature by intentional interruption of the mains voltage are precluded.

Additionally, in a preferred embodiment according to the invention, display means are assigned to the control unit, which are provided on the refrigerator door and thus are easily visible from the outside and configured in such a manner that, in case of the mains voltage outage, a current internal temperature of the refrigerator device, in particular of the interior intended for storing goods to be refrigerated, can be displayed for the predetermined minimum period in response to said outage. Thus, in particular operators or other personnel are enabled to check a current internal temperature even during the malfunction, based on which they can make a decision as to whether the (potentially sensitive) refrigerated goods have to be removed from the interior—by proper code entry—and to be stored elsewhere or whether the refrigerated goods can remain in the interior, such as in case of continued sufficient insulation and a correspondingly sufficient storage temperature.

As a result, the ease of security as well as of access and information of generic refrigerator devices, in particular in the ultra-low temperature cooling range for sensitive goods, is significantly improved, whereby, in addition to effective abuse prevention, increased access security in connection with improved operating behavior is made possible.

In an advantageous embodiment of the invention, the blocking means have, as a blocking element, a blocking bolt which can be electromotively displaced in a linear direction and which can engage, in particular in an otherwise known force-locking manner, into a portion of the locking lever, such as a bore formed therein, in order to ensure the blocking. In this way, the blocking function can be realized in a mechanically secure and, at the same time, electromotively realized simple manner and thus at little production effort, and the blocking function can additionally be improved further by the electromotively driven blocking bolt being held normally stable at least in the end position or stop position enabling the blocking. This has the advantageous effect that, in synergy with the inventive idea described above, the blocking bolt remains in the locked position even in case of the state of emergency of a power outage. Additionally, a normally stable extended state of this kind allows for a low electrical energy consumption, in particular of the electromotive components involved in this blocking process. Further preferred, by suitable design of the involved actors, for example, the blocking bolt movement is bistable on both sides, meaning it merely requires an electrical driving signal for the actual movement.

An additional and preferred embodiment of the invention provides that detector and/or switching means are assigned to the blocking bolt which in particular indicate a release, namely a retracted displaced position of the blocking bolt. This can advantageously be realized in practice by the blocking bolt touching and thus closing a mechanical switching contact when the blocking bolt is in the retracted displaced position effecting the release. Accordingly, the connected control unit is able to reliably detect this open state or unblocked state and to take it into account for other controlling and display tasks, as appropriate.

According to another preferred embodiment of the invention, which can be provided in combination with the embodiments described above but also alternatively to or independently from them, pivoted-position detector means are assigned to the locking lever and connected to the control unit in such a manner that a pivoted state or a pivoted position of the locking lever, namely the open and locked position in particular, are electronically detectable and evaluable. To realize this advantageous embodiment, which can make subsequent actuation of the blocking bolt with the aim of unblocking and potential later re-blocking dependent on the appropriate (mechanical) pivoted positions of the locking lever, the locking lever function is directly incorporated in the control behavior of the device. According to the embodiment, it is advantageous first of all to arrange the pivoted-position detector means on the refrigerator door, adjacent to the locking lever and preferably in contactless interaction therewith, not least since control lines and electronic components of the like are present on and/or in the refrigerator door anyway, such as for the display means. In another preferred embodiment, it is additionally simple and cost-effective in terms of implementation and operationally safe in the context at hand to realize the pivoted-position detector means in the form of magnetic field detectors or magnetically actuatable switches which can interact, in a particularly suitable and advantageous (and further advantageously contactless) manner, with permanent magnet means provided and formed on the locking lever itself. In this way, reliable contactless detection can be realized without having to provide lines or other electronic components on the locking lever itself. Moreover, the magnetic field detector means or the magnetically actuated switch means will allow easy and comfortable signal evaluation.

With the purpose of preventing unintended operating states in the case of a prolonged mains voltage outage, it may be advantageous according to another embodiment for the control unit according to the invention to be configured in such a manner that code actuation and/or release is restricted during the mains voltage outage and can in particular be performed only once.

As a result, the advantageous embodiments of the invention as corresponding to the dependent claims also allow the advantageous protective properties and operative properties as made possible by the invention to be realized, in particular in the sensitive context of ultra-low temperature refrigerator devices.

### BRIEF DESCRIPTION OF THE DRAWINGS

Other advantages, features and details of the invention are apparent from the following description of preferred embodiments and from the drawings that reveal:

FIG. 1: a schematic illustration of the mains voltage-operated refrigerator device according to a first embodiment, in which electronic and electromechanical functional components supplement the functions of the locking lever at the refrigerator door as shown in the figure in the manner of a block diagram.

### DETAILED DESCRIPTION

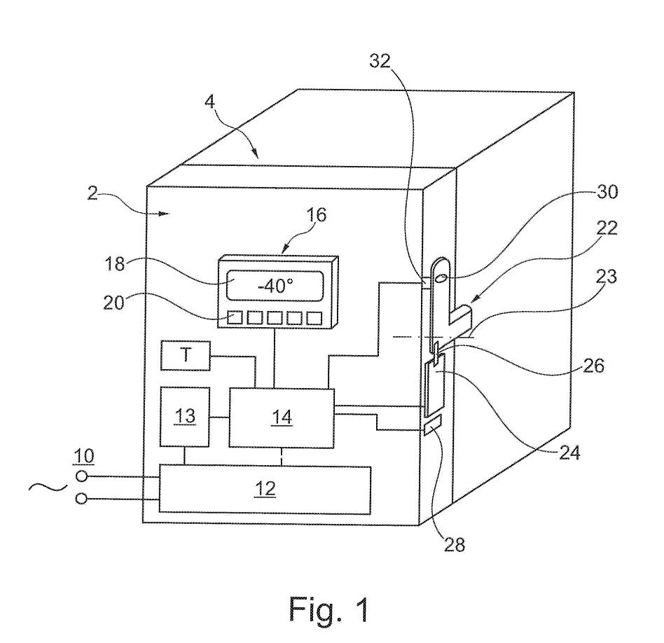

FIG. 1 illustrates a first embodiment of the mains voltage-operated refrigerator device of the present invention. The schematic perspective view of FIG. 1 shows a refrigerator which can be connected to a (preferably public) voltage supply network via a mains voltage input 10, the refrigerator having a refrigerator door 2 which, in a manner not shown in FIG. 1, closes an interior intended for storing refrigerated goods and cooled to a cooling mode temperature of −80 ° C. when in a stationary cooling state. Said temperature is detected by a temperature sensor T assigned to the interior.

In an otherwise known manner, refrigerator door 2, which is pivotably hinged to a refrigerator body 4 surrounding the interior (not shown), can be opened (and closed) by manual operation of a locking lever 22 which can be pivoted about a horizontal pivot axis 23; in this regard, the illustration of FIG. 1 shows the closed state, in which locking lever 22 engages counter bearing means (not shown) on body 4.

In its closed position (FIG. 1), locking lever 22 is secured against unauthorized access by the effect of a blocking device (blocking means) 24 which forms a blocking bolt 26 that can be extended in the direction of lever 22 and engages into the latter in a blocking manner when in its blocked state. Said blocking bolt can, in turn, be actuated in a vertical direction of FIG. 1 within housing 24 by an electromotively driven helical drive, namely between a retracted (open or unblocked) position, in which blocking bolt 26 is disengaged from lever 22 (thus releasing the latter for actuation), and a locked state, in which blocking bolt 26 is extended in the manner described above and prevents locking lever 22 from being pivoted by engaging into a suitable opening or bore in locking lever 22.

Said electromotive actuation of the blocking bolt is controlled by a control unit 14, which is schematically shown in FIG. 1 and which, being realized by means of a microcontroller unit, for example, and provided with suitable operating (system) software, executes the locked and unlocked states of locking lever 22 by appropriately controlling the motor actuating blocking bolt 26.

FIG. 1 additionally shows a display and entry unit 16 which is assigned to control unit 14 and which has a temperature display 18 for an interior cooling temperature (depending on a sensor output signal of temperature sensor T) and a schematically shown keyboard 20 via which a correct code will have to be entered in order to effect the opening operation of blocking means 24 and thus to release blocking bolt 26.

As FIG. 1 additionally clarifies, sensor means in the form of a limit switch 28 and of a magnetic detector 32 are provided and assigned to control unit 14 in order to influence the blocking and unblocking operations: at first, it is determined by means of limit switch 28 mechanically actuated by the blocking bolt in the open (lowered) state whether blocking bolt 26 is in an unlocked state or in a state suitable for opening. Moreover, it is determined by means of the magnetic field detector, which is realized by a reed switch on refrigerator door 2, for example, and configured to interact with a permanent magnet 30 attached to locking lever 22 on the opposite side, whether the locking lever is in the locked position (FIG. 1) since, in this position, permanent magnet 30 is located opposite reed switch 32, which enables corresponding detection by control unit 14. In this locked position only, locking could be performed by raising blocking bolt 26 (as functional unit 24 is being controlled accordingly) so that a malfunction of the blocking bolt can be effectively prevented. This is in particular because combination 30, 32 prevents blocking bolt 26 from being actuated to lock in this way when locking lever 22 is in a wrong position, such as in a pivoted state.

As additionally clarified by the block diagrams introduced into the illustration of FIG. 1, the embodiment is provided with an emergency function for the event of an (unintentional) interruption or outage of the mains voltage at connection 10. That is, the mains voltage is primarily used to supply cooling components and associated control units for cooling the interior of the refrigerator to the intended target temperature, as schematically symbolized by functional unit 12. Said units are known per se and are not illustrated or described separately.

At the same time, a battery-operated buffering unit 13 is provided, which, when the refrigerator device is connected to mains voltage 10, receives said mains voltage (suitably processed by mains adapter means (not shown)) and buffers it in such a manner that an emergency mode (to be explained below) of control unit 14 including display and entry unit 16, 18, 20 connected thereto can be ensured across a minimum operating period of 72 hours without a connected mains voltage signal. In this emergency mode, control unit 14 is still capable of continuously detecting a cooling temperature of the interior of the refrigerator via temperature sensor T sensing into said interior, of digitally processing said cooling temperature in a suitable manner and of displaying it on display 14 of display and entry unit 16, which is installed on the front outer surface of door 2. This cooling temperature does not have to be displayed continuously; instead, it can be displayed when an interface is actuated, as symbolically illustrated by a row of keys 20 (wherein said interface can alternatively also be realized by a touch-sensitive function of display unit 18, such as in the manner of a known touch screen). Battery buffering unit 13 ensures that said function is maintained during said minimum period of 72 hours. Moreover, power supply 14 also ensures that the aforementioned code-secured release and opening operation of unit 24 can be effected (at least) once by controlling control unit 14: This is because, even during the power outage, release of the locking lever by lowering blocking bolt 26 requires a release signal from the control unit 14 by action of blocking means 24, said signal being generated only if an operator has entered a correct code via keys 20.

Within the scope of the embodiment according to the invention, the operator will have read the temperature display on display 18 before opening the refrigerator in order to make sure that opening the refrigerator is in fact a suitable measure to access the content of the refrigerator, i.e. with the intent of transferring its contents to a working refrigerator.

In this advantageous embodiment of the invention, the display is additionally capable of displaying an operating state, in particular an error report, in addition to the temperature during the minimum display period during the outage. In this way, operating or maintenance personnel can (additionally) gather information on the refrigerator, such as on the fact whether the outage is (actually) due to purely external reasons or whether functional unit 12 might be defective. This, too, is merely an example. This advantageous function on the display can also be used in particular to give advice to the operator, by displaying an emergency notice, on how to proceed (in order to correct the malfunction, for example).

Moreover, the emergency opening function described above (including required code entry according to the invention) permits the refrigerator to be opened only once, thus in particular preventing subsequent locking unless proper mains voltage supply at connection 10 has been reestablished in the meantime (and initializing and rebooting processes of the operating system associated with control unit 14 have taken place, if necessary).

The invention is not limited to the illustrated embodiment. Realization of the invention does not require the specific use and environment parameters—that is, the present invention is particularly beneficial and useful in the context of ultra-low temperature refrigerator devices, but other uses are conceivable as well—nor do the locking and blocking functions necessarily have to happen in the specific manner described; in this context, too, numerous other electromechanical solutions are imaginable.

1. A mains voltage-operated refrigerator device, in particular an ultra-low temperature refrigerator device, comprising
a refrigerator door (2) comprising a locking lever (22) hinged thereto, said locking lever being pivotable between an open position and a locked position,
and blocking means (24) assigned to the locking lever and comprising an electromotively and/or electromagnetically actuated blocking element (26)
which blocks or releases the pivoting of the locking lever as a function of a code actuation that can be entered by an operator by means of a code entry unit (20), wherein
an electronic control unit (14) and mains voltage-independent battery buffering means (13) are assigned to the blocking means and to the code entry unit in such a manner that in response to a mains voltage outage, code actuation and release are enabled for a predetermined minimum period without mains voltage supply,
wherein display means (18) assigned to the control unit are configured in such a manner that a current internal temperature of the refrigerator device can be displayed during the mains voltage outage and at least for the predetermined minimum period.

2. The device according to claim 1, wherein the predetermined minimum period is 50 hours.

3. The device according to claim 1, wherein the blocking means comprises an electromotively linearly displaceable blocking bolt (26) as blocking element which during blocking can engage into a portion of the locking lever.

4. The device according to claim 3, wherein the blocking means are configured in such a manner that the blocking bolt is held normally stable in the end position or stop position enabling blocking.

5. The device according to claim 3, wherein the blocking means comprise detector and/or switch means (24) which are connected to the control unit and which serve to detect a displaced position of the blocking bolt.

6. The device according to claim 1, wherein pivoted-position detector means (30, 32) are assigned to the locking lever and are connected to the control unit.

7. The device according to claim 6, wherein the pivoted-position detector means comprise magnetic-field detector means (32) and/or magnetically actuatable switch means, which are configured to magnetically interact with permanent magnet means (30) provided on the locking lever, or a position sensor or a switch configured for contact or noncontact actuation.

8. The device according to claim 1, wherein the control unit is configured in such a manner that code actuation and/or release in response to the mains voltage outage is enabled for a predetermined number of times only.

9. The device according to claim 1, wherein the control unit and the display unit are configured to additionally display malfunction information, operating state information and/or operating instruction information during the minimum period.

10. The device according to claim 1, wherein an interior intended for storing goods to be refrigerated is operated at a stationary cooling mode temperature of <−50 ° C., preferably <−80 ° C.

11. The device according to claim 1, wherein the display means (8) is provided on the refrigerator door.

12. The device according to claim 1, wherein the predetermined minimum period is 70 hours.

13. The device according to claim 3, wherein the blocking bolt (26) engages in a force-locking manner into the portion of the locking lever.

14. The device according to claim 4, wherein the blocking means are configured to drive the blocking bolt into normally bistable end positions.

15. The device according to claim 5, wherein the detector and/or switch means (24) serve to detect a retracted displaced position of the blocking bolt which effects release.

16. The device according to claim 5, wherein the detector and/or switch means (24) are realized as mechanical switch means (24) that can be actuated by the blocking bolt.

17. The device according to claim 6, wherein the pivoted-position detector means (30, 32) are provided on the refrigerator door.

18. The device according to claim 8, wherein the predetermined number of times is only once.

19. The device according to claim 8, wherein a blocking and/or locking operation is prevented.
